(19) United States
(12) Patent Application Publication
(10) Pub. No.: US 2008/0084708 A1
(43) Pub. Date: Apr. 10, 2008

(54) Linear light source using point light source

(75) Inventors: Hong-seok Lee, Yongin-si (KR); Su-mi Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/783,681

(22) Filed: Apr. 11, 2007

(30) Foreign Application Priority Data
Oct. 4, 2006 (KR) 10-2006-0097604

(51) Int. Cl. F21V 8/00

(52) U.S. Cl. 362/612; 362/621

(57) ABSTRACT

A linear light source using a point light source is provided. The linear light source includes: a bar-shaped light guide panel (LGP) having two lateral sides and four longitudinal sides; at least one point light source emitting light into the LGP through at least one of the two lateral sides of the LGP; and a plurality of radiating elements, projecting out from at least one of the four longitudinal sides of the LGP, which totally reflects light incident into the LGP and radiates the totally reflected light outside the LGP. Each of the plurality of radiating elements has a reflecting surface that totally reflects light and an exit surface through which the reflected light is radiated.

### CROSS-REFERENCE TO RELATED PATENT APPLICATION

This application claims priority from Korean Patent Application No. 10-2006-0097604, filed on Oct. 4, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a linear light source used in a liquid crystal display (LCD) or illumination device, and more particularly, to a linear light source emitting linear light using a point light source such as a light-emitting diode (LED).

2. Description of the Related Art

Liquid crystal displays (LCDs) are widely used nowadays due to their light weight and low power consumption. Because an LCD is a non-emissive flat panel display that uses light from an external source to produce an image, it requires an illumination device such as a back light or front light.

Illumination devices used in LCDs are classified as either direct light type illumination devices or edge light type devices according to the position of a light source. In the case of a direct light type device, a plurality of lamps disposed beneath an LCD panel directly emit light onto the LCD panel. In the case of an edge light type device, a lamp located on a sidewall of a planar light guide panel (LGP) emits light onto the LCD panel through the LGP.

An edge-light type illumination device uses a linear light source and a point light source as a light source. Representative examples of the linear light source and point light source are a cold cathode fluorescent lamp (CCFL) and an LED, respectively. As display devices have become slimmer, demands for illumination devices using point light sources, such as thin, high efficiency LEDs, have increased.

FIG. 1 illustrates a related art LCD and FIG. 2 is a schematic perspective view of a backlight unit shown in FIG. 1.

Referring to FIGS. 1 and 2, the LCD includes a backlight unit as an illumination device, which is disposed behind an LCD panel 10 and illuminates the LCD panel 10. The backlight unit includes four LEDs 40 and a planar LGP 30 allowing light incident from the LED 40 to exit toward the LCD panel 10.

More specifically, the four LEDs 40 are located at regular intervals along a sidewall of the LGP 30. Light emitted by each of the four LEDs 40 enters the LGP 30 through an incident surface 31. A light path changing element, such as a dot print pattern 35, is disposed at a bottom surface of the LGP 30 to change the path of the light incident into the LGP 30 so that the light exits through an exit surface 33 of the LGP 30. The light exiting through the exit surface 33 of the LGP 30 passes through a diffusion plate 21, prism sheets 22 and 23, and/or a protector 24 and is then incident on the LCD panel 10. Instead of the dot print pattern 35, a hologram pattern, inverted prism pattern, or inverted trapezoidal pattern may be used as the light path changing element. The backlight unit further includes a reflective plate 50 that is disposed below the LGP 30 and reflects light exiting the LGP 30.

FIG. 3A is a photograph illustrating the brightness distribution on an exit surface in the related art backlight unit of FIG. 2 and FIG. 3B is a graph illustrating the distribution of brightness taken along line A-A′ in FIGS. 2 and 3A.

Referring to FIGS. 3A and 3B, the related art backlight unit having the above-mentioned configuration has a limited radiation angle of light emitted by the LED 40 (the point light source). Due to this limitation, light rays emitted from the plurality of LEDs 40 may overlap one another in the LGP 30 or some of the light rays may not reach the LGP 30. Thus, as evident from FIGS. 3A and 3B, the brightness of light exiting through the exit surface 33 of the LGP 30 has a non-uniform distribution. This phenomenon becomes severe at a region of the LGP 30 adjacent to the incident surface 31. Bright and/or dark lines can easily be seen at the region adjacent to the incident surface 31 of the LGP 30.

The conventional backlight unit has a drawback in that the region in the LGP 30 having a non-uniform brightness distribution is not used as an effective area for illuminating the LCD panel 10.

### SUMMARY OF THE INVENTION

Exemplary embodiments of the present invention provide a linear light source using a point light source to emit linear light, thus offering an improved uniformity of brightness distribution.

According to an exemplary aspect of the present invention, there is provided a linear light source including: a bar-shaped light guide panel (LGP) having two lateral sides and four longitudinal sides; at least one point light source emitting light in the LGP through at least one of the two lateral sides of the LGP; and a plurality of radiating elements, projecting out from at least one of the four longitudinal sides of the LGP, which totally reflect light incident into the LGP and radiate the totally reflected light outside the LGP, wherein each of the plurality of radiating elements has a reflecting surface that totally reflects light and an exit surface through which the reflected light is radiated.

The at least one point light source may be a light-emitting diode (LED). The point light source may be disposed to face either of the two lateral sides of the LGP or may be tilted at a predetermined angle with respect to the lateral sides of the LGP.

The point light source may be thicker than the LGP. The linear light source may further include a coupling disposed between the point light source and the LGP and tapering away from the point light source toward the LGP.

The plurality of radiating elements may be integrally formed with the LGP.

The reflecting surface of each of the plurality of radiating elements may be inclined at a predetermined angle or curved.

The exit surface of each of the plurality of radiating elements may have a tetragonal shape. The radiating element may have a trapezoidal shape that tapers toward the LGP.

The exit surface of each of the plurality of radiating elements may have a circular or elliptical shape. The radiating element may have a conical shape with a vertical cross-section tapering toward the LGP.

The linear light source may further include a frame protecting the LGP, the point light source, and the plurality of radiating elements. The frame may have a shape that covers all the sides except for a side in which the plurality of radiating elements are formed. The frame may have an interior reflecting surface that reflects light leaving the LGP back into the LGP. A pattern selected from the group consisting of a prism pattern, a lens pattern, a scattering pattern, and a diffraction grating pattern may be formed in the reflecting surface of the frame.

The plurality of radiating elements may be formed in a first side of the four longitudinal sides and one selected from the group consisting of a prism pattern, a lens pattern, a scattering pattern, and a diffraction grating pattern may be formed in a second side opposite the first side. The prism pattern may include a plurality of prisms elongated in a length or thickness direction of the LGP. The lens pattern may include a plurality of lenses elongated in a length or thickness direction of the LGP.

The plurality of radiating elements may be formed in two opposing sides of the four longitudinal sides of the LGP or in the four longitudinal sides of the LGP.

### BRIEF DESCRIPTION OF THE DRAWINGS

The above and other exemplary aspects and advantages of the present invention will become more apparent by the following detailed description of exemplary embodiments thereof with reference to the attached drawings in which:

FIG. 1 illustrates the configuration of a related art liquid crystal display (LCD);

FIG. 2 is a schematic perspective view of the backlight unit shown in FIG. 1;

FIG. 3A illustrates a brightness distribution on an exit surface in the related-art backlight unit of FIG. 2;

FIG. 3B is a graph illustrating the distribution of brightness taken along line A-A′ in FIGS. 2 and 3A;

FIG. 4 is a perspective view of a linear light source according to an exemplary embodiment of the present invention;

FIG. 5 is a plan view illustrating an example in which the linear light source of FIG. 4 is applied to an illumination device for an LCD;

FIG. 6 is a plan view illustrating another example of a reflecting surface of each of the radiating elements shown in FIG. 4;

FIGS. 7A and 7B are perspective views illustrating modified examples of the radiating elements shown in FIG. 4;

FIG. 8 is a plan view of another arrangement of the point light source shown in FIG. 4;

FIG. 9 is a perspective view illustrating another example of the point light source shown in FIG. 4;

FIGS. 10A through 10E are perspective views illustrating modified examples of the light guide panel (LGP) shown in FIG. 4;

FIG. 11 is a perspective view illustrating a modified example of the frame shown in FIG. 4;

FIG. 12 is a perspective view of a linear light source according to another exemplary embodiment of the present invention;

FIG. 13 is a perspective view of a linear light source according to another exemplary embodiment of the present invention;

FIG. 14A illustrates the distribution of brightness of light emitted from the linear light source of FIG. 4 and FIGS. 14B and 14C are graphs respectively illustrating brightness distributions along the X- and Y-axis direction indicated in FIG. 14A; and

FIG. 15A illustrates the distribution of brightness of light radiating through an exit surface in an illumination device for an LCD employing a linear light source according to an embodiment of the present invention as shown in FIG. 4; and

FIGS. 15B and 15C are graphs respectively illustrating brightness distributions along the X- and Y-axis direction indicated in FIG. 15A.

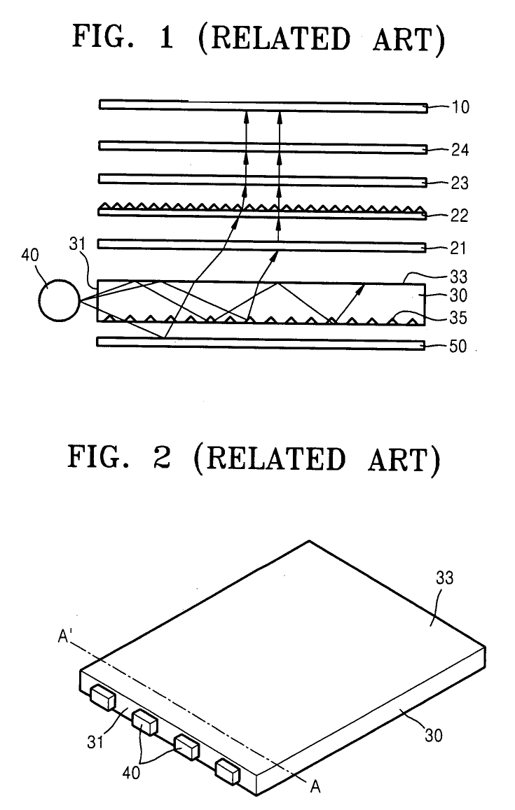

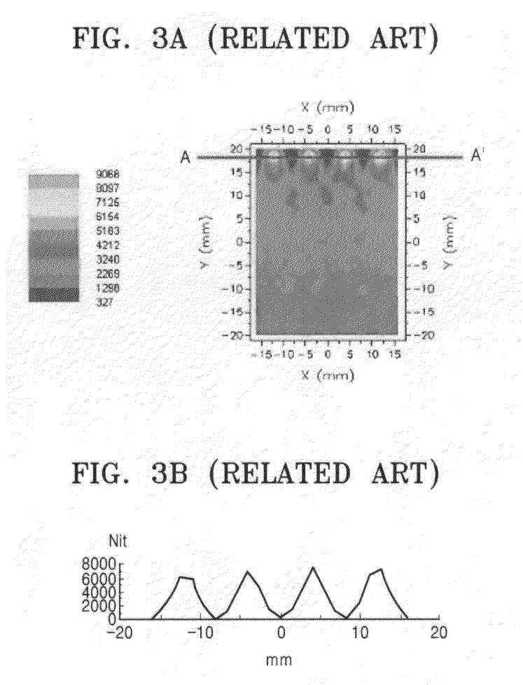

### DETAILED DESCRIPTION OF EXEMPLARY EMBODIMENTS OF THE INVENTION

Exemplary embodiments of present invention will now be described more fully with reference to the accompanying drawings, in which exemplary embodiments of the invention are shown. Like reference numerals in the drawings denote like elements, and thus their description will be omitted.

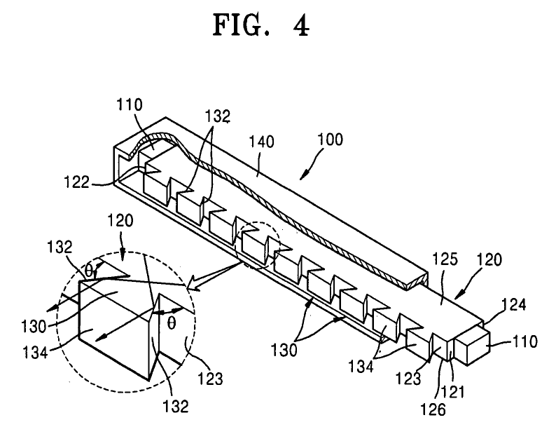

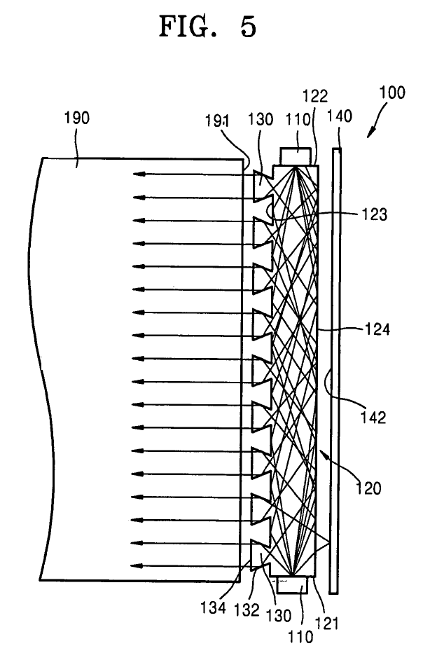

FIG. 4 is a perspective view of a linear light source 100 according to an exemplary embodiment of the present invention and FIG. 5 is a plan view illustrating an example in which the linear light source 100 is used in an illumination device for a liquid crystal display (LCD).

Referring to FIGS. 4 and 5, the linear light source 100 includes at least one point light source 110, a light guide panel (LGP) 120 receiving light emitted by the point light source 110, and a plurality of radiating elements 130 allowing light incident into the LGP 120 to exit in a linear form.

The LGP 120 has a bar shape with two lateral sides 121 and 122 and four longitudinal sides 123 through 126. The longitudinal sides run in the lengthwise direction of the LGP, and the lateral sides are orthogonal to the longitudinal sides.

An LED may be used as the point light source 110. The LED 110 is disposed to face either of the two lateral sides 121 and 122 of the LGP 120 and emits light into the LGP 120 through the lateral sides 121 or 122.

The plurality of radiating elements 130 are integrally formed with the LGP 120, thereby preventing problems such as the scattering of light at a boundary between the plurality of radiating elements 130 and the LGP 120.

The plurality of radiating elements 130 project out from one of the four longitudinal sides 123 through 126 of the LGP 120, e.g., the first longitudinal side 123, from which light will be emitted. The plurality of radiating elements 130 totally reflect light incident into the LGP 120 and radiate the totally reflected light outside the LGP 120. To achieve this function, each of the plurality of radiating elements 130 has a reflecting surface 132 that totally reflects light and an exit surface 134 through which the reflected light is emitted.

Each of the plurality of radiating elements 130 has a rectangular exit surface 134 and a reflecting surface 132 inclined at a predetermined angle Θ. Thus, each radiating element 130 has an approximately trapezoidal shape that tapers toward the LGP 120. The inclination angle Θ of the reflecting surface 132 may vary depending on the angular distribution of light incident from the LED 110 and desired distribution of light exiting through the exit surface 134. The inclination angle Θ of the reflecting surface 132 may be an angle (for example. 54.5°) at which incident light having the highest intensity can be totally reflected by the reflecting surface 132 and radiated perpendicular to the exit surface 134. The reflecting surfaces 132 of the plurality of radiating elements 130 may have equal or different inclination angles.

The plurality of radiating elements 130 may be arranged at equal or different intervals along the first longitudinal side 123 of the LGP 130. Further, each of the plurality of radiating elements 130 may have different sizes. That is, the distribution of light exiting through the plurality of radiating elements 130 and exit angle distribution can be adjusted by adjusting the inclination angle Θ of the reflecting surface 132 of each of the plurality of radiating elements 130, intervals at which the plurality of radiating elements 130 are arranged, and the sizes of the radiating elements 130.

The linear light source 100 further includes a frame protecting the LEDs 110, the LGP 120, and the plurality of radiating elements 130. The frame 140 has a shape that covers all the sides except for the first longitudinal side 123 in which the plurality of radiating elements 130 are formed, i.e., the two lateral sides 121 and 122 and the three longitudinal sides 124 through 126. The frame 140 has an interior reflecting surface 142 that reflects light leaving the LGP 120 back into the LGP 120.

Referring to FIG. 5, the linear light source 100 may be a light source for an illumination device for an LCD such as a backlight unit. The linear light source 100 is located along a side of a planar LGP 190 of a backlight unit. More specifically, the linear light source 100 is disposed such that the exit surfaces 134 of the plurality of radiating elements 130 face the side of the planar LGP 190 that is an incident surface 191.

Light emitted by the LEDs 110 is incident into the LGP 120 through the two lateral sides 121 and 122 of the LGP 120, is totally reflected by the reflecting surfaces 132 of the plurality of radiating elements 130, and exits through the exit surfaces 134 thereof. On the other hand, light exiting through the second longitudinal side 124 of the LGP 120 is reflected by the reflecting surface 142 of the frame 140 back into the LGP 120.

As described above, the light exiting through the exiting surfaces 134 of the plurality of radiating elements 130 is entirely linear and is incident into the planar LGP 190 through the incident surface 191 thereof. In this manner, the linear light source 100 according to the present invention does not directly use light emitted by the point light sources 110 but converts the light into linear light before use. Thus, the linear light source 100 achieves a uniform distribution of output light along the lateral direction, thereby providing an improved brightness distribution at an incident portion of the LGP 190. This advantage of the present invention will be described in more detail later with reference to experimental results.

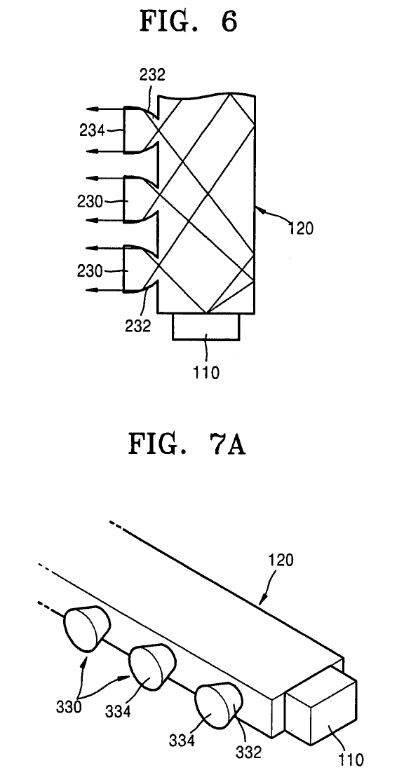

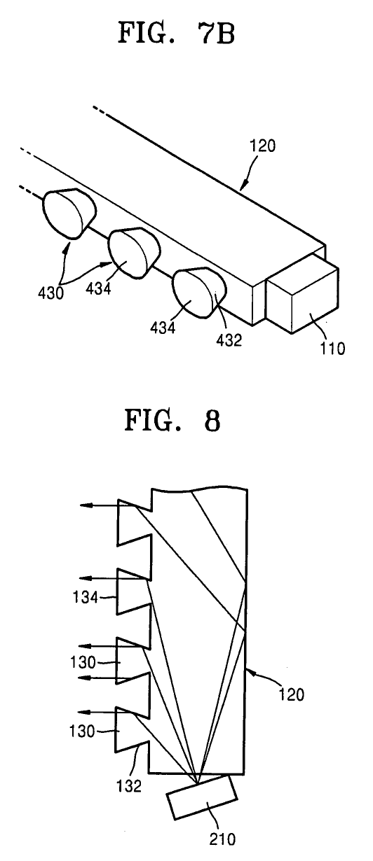

FIG. 6 is a plan view illustrating another example of the reflecting surface 132 of the radiating element 130 shown in FIG. 4 and FIGS. 7A and 7B are perspective views illustrating modified examples of the radiating elements 130 shown in FIG. 4.

Referring to FIG. 6, each of a plurality of radiating elements 230 has an exit surface 234 and a curved reflecting surface 232. Referring to FIG. 7A, since each of a plurality of radiating elements 330 has a circular exit surface 334, it has an approximately conical shape with a vertical cross-section tapering toward the LGP 120. In this case, each radiating element 330 has a reflecting surface 332 that is an outer circumferential surface. Referring to FIG. 7B, since each of a plurality of radiating elements 330 has an approximately elliptical exit surface 434, it has an approximately conical shape with a vertical cross-section tapering toward the LGP 120. In this case, each radiating element 330 has a reflecting surface 332 that is an outer circumferential surface.

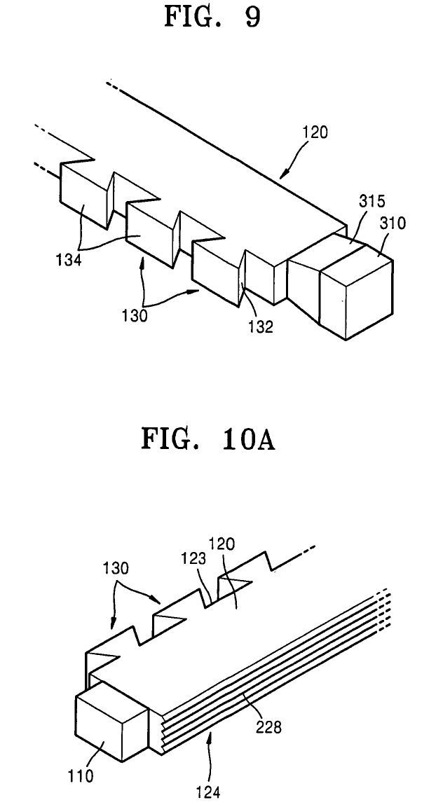

FIG. 8 is a plan view of another arrangement of the point light source 110 shown in FIG. 4 and FIG. 9 is a perspective view illustrating another example of the point light source 110 shown in FIG. 4.

Referring to FIG. 8, an LED 210 is tilted at a predetermined angle with respect to a lateral axis of the LGP 120. This configuration allows for a more efficient use of the center of light emitted by the LED 210.

Referring to FIG. 9, an LED 310 has a thickness greater than that of the LGP 120. A coupling 315 is disposed between the LED 310 and the LGP 120 and guides light emitted by the LED 310 into the LGP 120. The coupling 315 tapers away from the LED 310 toward the LGP 120 so that light emitted by the LED 310 thicker than the LGP 120 can be incident into the LGP 120 without loss.

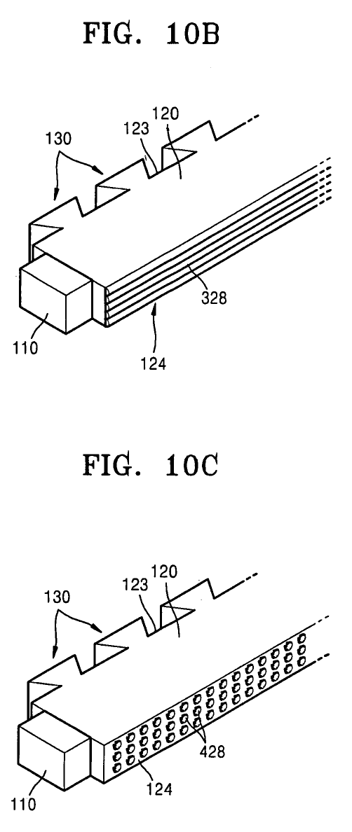

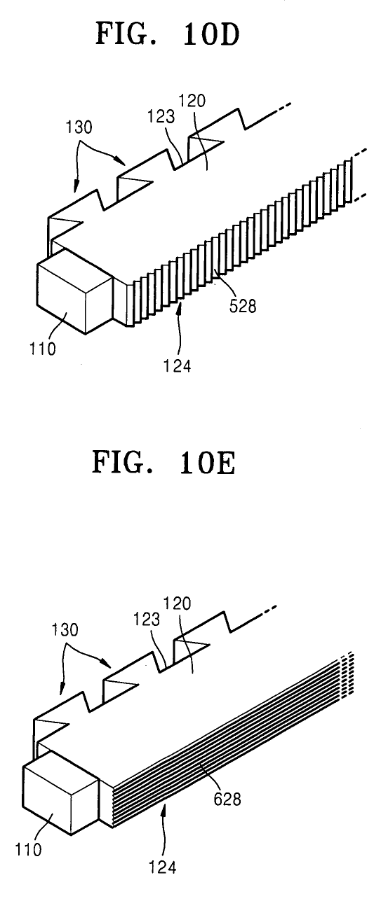

FIGS. 10A through 10E are perspective views illustrating modified examples of the LGP 120 shown in FIG. 4 and FIG. 11 is a perspective view illustrating a modified example of the frame 140 shown in FIG. 4.

Referring to FIG. 10A, a prism pattern 228 is formed in the second longitudinal side 124 opposite the first longitudinal side 123 of the LGP 120 with the plurality of radiating elements 130. The prism pattern 228 consists of a plurality of prisms elongated in a length direction of the LGP 120. Referring to FIG. 10B, a lens pattern 328 is formed in the second longitudinal side 124 of the LGP 120. The lens pattern 328 consists of a plurality of lenses elongated in the length direction of the LGP 120. Referring to FIG. 10C, a scattering pattern 428 is formed in the second longitudinal side 124 of the LGP 120. Referring to FIG. 10E, a diffraction grating pattern 628 is formed in the second longitudinal side of the LGP 120.

The prism pattern 228, the lens pattern 328, the scattering pattern 428, and the diffraction grating pattern 628, shown in FIGS. 10A through 10C, and 10E, are used to control the vertical angular distribution of light reflected from the second longitudinal side 124 of the LGP 120.

Referring to FIG. 10D, a prism pattern 528 is formed in the second longitudinal side 124 of the LGP 120. The prism pattern 528 consists of a plurality of prisms elongated in a thickness direction of the LGP 120. The prism pattern 528 is used to control horizontal angular distribution of light reflected from the second longitudinal side of the LGP 120.

Alternatively, the prism pattern 228 or 528, the lens pattern 328, the scattering pattern 428, or the diffraction grating pattern 628 may be formed on a frame 240 in FIG. 11. For example, referring to FIG. 11, a prism pattern 248 having a plurality of prisms elongated in the length direction of the LGP 120 is formed in an interior surface, i.e., a reflecting surface 242 of the frame 240 opposite the second longitudinal side 124 of the LGP 120. The prism pattern 248 is used to control the vertical angular distribution of light reflected from the reflecting surface 242 of the frame 240.

As described above, the prism pattern 228, 248, or 528, the lens pattern 328, the scattering pattern 428, or the diffraction grating pattern 628 formed in the second longitudinal side 124 of the LGP 120 or on the interior reflecting surface 242 of the frame 240 is used to control the vertical or horizontal angular distribution of light, thus optimizing light radiated from the plurality of radiating elements 130 according to the desired radiation distribution and increasing radiation efficiency.

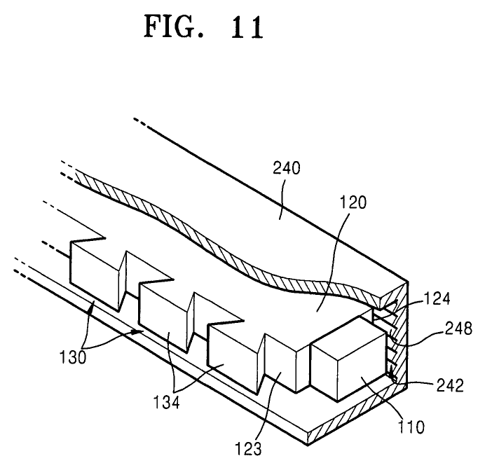

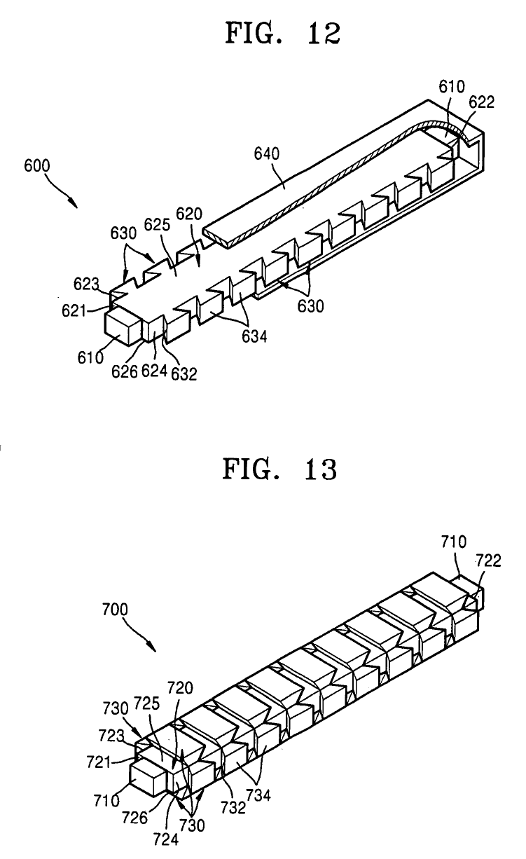

FIG. 12 is a perspective view of a linear light source 600 according to another exemplary embodiment of the present invention, and FIG. 13 is a perspective view of a linear light source 700 according to another exemplary, embodiment of the present invention.

First, referring to FIG. 12, the linear light source 600 includes at least one (for example, two) point light source 610 that is an LED, an LGP 620 receiving light emitted by the LED 610, and a plurality of radiating elements 630 radiating light incident into the LGP 620.

The LED 610 is disposed to face either of two lateral sides 621 and 622 of the LGP 620 and emits light into the LGP 620 through the lateral sides 621 and 622. The plurality of radiating elements 630 are integrally formed with the LGP 620. The plurality of radiating elements 630 project out from two opposing sides (e.g., the first and second longitudinal sides 623 and 624) of the four longitudinal sides 623 through 626 of the LGP 620. The plurality of radiating elements 630 totally reflect light incident into the LGP 620 and radiate the totally reflected light through the two longitudinal sides 623 and 624 of the LGP 620. To achieve this function, each of the plurality of radiating elements 630 has a reflecting surface 632 that totally reflects light and an exit surface 634 that radiates the reflected light.

The linear light source 600 further includes a frame protecting the LEDs 610, the LGP 620, and the plurality of radiating elements 630. The frame 140 has a shape that covers all the sides except for the two longitudinal sides 623 and 624 in which the plurality of radiating elements 130 are formed, i.e., the two lateral sides 621 and 622 and the two longitudinal sides 625 and 626.

The modified examples illustrated in FIGS. 6 through 9 can also be applied to the linear light source 600 of FIG. 12.

Referring to FIG. 13, the linear light source 700 includes at least one (for example, two) point light source 710 that is an LED, an LGP 720 receiving light emitted by the LEDs 710, and a plurality of radiating elements' 730 radiating light incident into the LGP 720.

The LED 710 is disposed to face either of two lateral sides 721 and 722 of the LGP 720 and emits light into the LGP 720 through the lateral sides 721 and 722. The plurality of radiating elements 730 are integrally formed with the LGP 620. The plurality of radiating elements 730 project out from four longitudinal sides 723 through 726 of the LGP 720. The plurality of radiating elements 730 totally reflect light incident into the LGP 720 and radiate the totally reflected light through the four longitudinal sides 723 through 726 of the LGP 720. To achieve this function, each of the plurality of radiating elements 730 has a reflecting surface 732 that totally reflects light and an exit surface 734 that radiates the reflected light.

The modified examples illustrated in FIGS. 6 through 9 can also be applied to the linear light source 700 of FIG. 13.

FIG. 14A illustrates a distribution of brightness of light emitted from the linear light source 100 in FIG. 4, and FIGS. 14B and 14C are graphs respectively illustrating brightness distributions along the X- and Y-axis directions indicated in FIG. 14A.

Referring to FIGS. 14 through 14C, light emitted from the linear light source 100 in FIG. 4 has an approximately uniform brightness distribution along the X- and Y-axis directions. In this case, the X- and Y-axis directions represent thickness and length directions of the LGP 120, respectively.

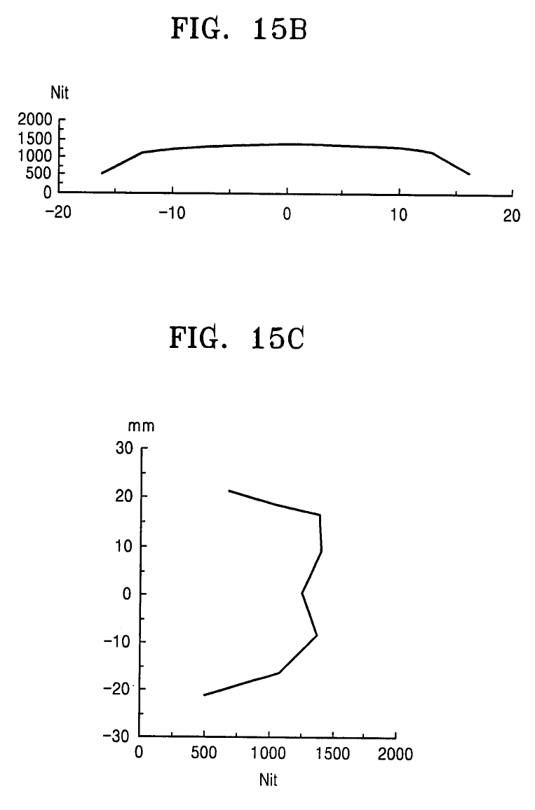

FIG. 15A illustrates a distribution of brightness of light radiating through an exit surface in an illumination device for an LCD employing a linear light source according to an embodiment of the present invention as shown in FIG. 4 and FIGS. 15B and 15C are graphs respectively illustrating brightness distributions along the X- and Y-axis directions indicated in FIG. 15A.

Referring to FIGS. 15A through 15C, when light emitted by the linear light source according to the present invention is incident on a planar LGP of a backlight unit for an LCD, the linear light source according to the present invention provides an entirely uniform brightness distribution of light exiting through an exit surface of the planar LGP, compared to a related art distribution. In particular, as shown in FIG. 15B, the uniformity of brightness distribution is improved along the X-axis direction (a length direction of the linear light source) at a region of the LGP near the incident surfaced thereof, thus preventing the occurrence of bright and/or dark lines at the region.

As described above, according to the present invention, a linear light source can be made from a point light source using LGP with a plurality of radiating elements. The linear light source of the present invention also provides an improved uniformity of brightness distribution of light emitted therefrom. Thus, light exiting through a planar LGP of an illumination device for an LCD employing the linear light source of the present invention has a more uniform brightness distribution. In particular, the uniformity of brightness distribution at a region of the planar LGP near the incident surface thereof, thus preventing the occurrence of bright and/or dark lines at the region. Thus, the effective area of the planar LGP for illuminating an LCD panel can be increased.

While the present invention has been particularly shown and described with reference to exemplary embodiments thereof, it will be understood by those of ordinary skill in the art that various changes in form and details may be made therein without departing from the spirit and scope of the present invention as defined by the following claims. For example, while in the above description, the linear light source is used for an illumination device for an LCD, it can be applied to other illumination devices. In particular, the linear light sources and illustrated in FIGS. 12 and 13 can be effectively used for a typical illumination device.

What is claimed is:

1. A linear light source comprising:
a bar-shaped light guide panel (LGP) having two lateral sides and four longitudinal sides;
at least one point light source which emits light into the LGP through at least one of the two lateral sides of the LGP; and
a plurality of radiating elements, projecting out from at least one of the four longitudinal sides of the LGP, which totally reflect light incident into the LGP and radiating the totally reflected light outside the LGP,
wherein each of the plurality of radiating elements has at least one reflecting surface that totally reflects light and an exit surface through which the reflected light is radiated.

2. The linear light source of claim 1, wherein the at least one point light source is a light-emitting diode (LED).

3. The linear light source of claim 1, wherein the at least one point light source is disposed to at least one of the two lateral sides of the LGP.

4. The linear light source of claim 1, wherein the at least one point light source is tilted at a predetermined angle with respect to the lateral sides of the LGP.

5. The linear light source of claim 1, further comprising a coupling disposed between the point light source and the LGP, which tapers away from the point light source toward the LGP, wherein the point light source is thicker than the LGP.

6. The linear light source of claim 1, wherein the plurality of radiating elements are integrally formed with the LGP.

7. The linear light source of claim 1, wherein the reflecting surface of each of the plurality of radiating elements is inclined at a predetermined angle.

8. The linear light source of claim 1, wherein the reflecting surface of each of the plurality of radiating elements is curved.

9. The linear light source of claim 1, wherein the exit surface of each of the plurality of radiating elements has a tetragonal shape.

10. The linear light source of claim 9, wherein each of the plurality of radiating elements has a trapezoidal shape that tapers toward the LGP.

11. The linear light source of claim 1, wherein the exit surface of each of the plurality of radiating elements has one of a circular and an elliptical shape.

12. The linear light source of claim 11, wherein each of the plurality of radiating elements has a conical shape with a vertical cross-section tapering toward the LGP.

13. The linear light source of claim 1, further comprising a frame which protects the LGP, the point light source, and the plurality of radiating elements.

14. The linear light source of claim 13, wherein the frame has a shape that covers all the sides except for a side in which the plurality of radiating elements are formed.

15. The linear light source of claim 13, wherein the frame has an interior reflecting surface that reflects light leaving the LGP back into the LGP.

16. The linear light source of claim 15, wherein a pattern, selected from a prism pattern, a lens pattern, a scattering pattern, and a diffraction grating pattern, is disposed in the reflecting surface of the frame.

17. The linear light source of claim 16, wherein the prism pattern comprises a plurality of prisms elongated in one of a length direction and a thickness direction of the LGP.

18. The linear light source of claim 16, wherein the lens pattern comprises a plurality of lenses elongated in one of a length direction and a thickness direction of the LGP.

19. The linear light source of claim 1, wherein the plurality of radiating elements are disposed in a first side of the four longitudinal sides and a pattern, selected from a prism pattern, a lens pattern, a scattering pattern, and a diffraction grating pattern, is disposed in a second side opposite the first side.

20. The linear light source of claim 19, wherein the prism pattern comprises a plurality of prisms elongated in one of a length direction and a thickness direction of the LGP.

21. The linear light source of claim 19, wherein the lens pattern comprises a plurality of lenses elongated in one of a length and a thickness direction of the LGP.

22. The linear light source of claim 1, wherein the plurality of radiating elements are disposed in two opposing sides of the four longitudinal sides of the LGP.

23. The linear light source of claim 1, wherein the plurality of radiating elements are disposed in the four longitudinal sides of the LGP.
